(19) United States
(12) Patent Application Publication
(10) Pub. No.: US 2025/0126536 A1
(43) Pub. Date: Apr. 17, 2025

(54) LAYER 1 OR LAYER 2 TRIGGERED MOBILITY FOR NON-TERRESTRIAL NETWORKS

(71) Applicant: QUALCOMM Incorporated, San Diego, CA (US)

(72) Inventors: Jelena DAMNJANOVIC, Del Mar, CA (US); Tao LUO, San Diego, CA (US)

(21) Appl. No.: 18/486,800

(22) Filed: Oct. 13, 2023

(51) Int. Cl. H04W 36/08; H04W 36/00

(52) U.S. Cl. CPC H04W 36/083; H04W 36/0058

(57) ABSTRACT

Various aspects of the present disclosure generally relate to wireless communication and to layer 1 or layer 2 (L1/L2) triggered mobility (LTM) for non-terrestrial networks (NTNs). In some aspects, a network node may transmit, and a user equipment (UE) may receive, a radio resource control (RRC) reconfiguration message associated with one or more LTM candidate NTN cells. The network node may transmit, and the UE may receive, an indication to perform LTM. In some aspects, the UE may perform, responsive to the one or more LTM candidate NTN cells being within a range of the UE, one or more layer 1 (L1) measurements associated with the one or more LTM candidate NTN cells. In some aspects, the UE may transmit, and the network node may receive, one or more L1 measurement reports associated with the one or more L1 measurements.

### FIELD OF THE DISCLOSURE

Aspects of the present disclosure generally relate to wireless communication and specifically, to techniques and apparatuses for layer 1 or layer 2 triggered mobility for non-terrestrial networks.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

Non-terrestrial networks (NTNs) involve larger handover (HO) delays and interruption times than terrestrial networks. For example, feeder link round trip times, the layer 3 (L3) signaling processing timeline, and random access channel (RACH)-based HOs can contribute to the large HO delays and interruption times. The large HO delay in NTNs can lead to radio link failures (RLFs). In fixed-cell scenarios, satellites overlap on the same area, during which time at least one user equipment (UE) (for example, a large number of UEs) can HO to a target cell, causing signaling overload. In moving-cell scenarios, satellite coverage can overlap and HO time is large, which can reduce robustness and lead to poor throughput. Furthermore, use of L3-based signaling for HOs in NTNs involves multiple configuration transmissions.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive a radio resource control (RRC) reconfiguration message associated with one or more layer 1 or layer 2 (L1/L2) triggered mobility (LTM) candidate non-terrestrial network (NTN) cells. At least one processor of the one or more processors may be configured to cause the UE to perform, after receiving the RRC reconfiguration message, LTM responsive to an indication to perform LTM.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit an RRC reconfiguration message associated with one or more LTM candidate NTN cells. At least one processor of the one or more processors may be configured to cause the network node to initiate, after transmitting the RRC reconfiguration message, LTM using an indication to perform LTM.

Some aspects described herein relate to a method of wireless communication performed by a UE. The method may include receiving an RRC reconfiguration message associated with one or more LTM candidate NTN cells. The method may include performing, after receiving the RRC reconfiguration message, LTM responsive to an indication to perform LTM.

Some aspects described herein relate to a method of wireless communication performed by a network node. The method may include transmitting an RRC reconfiguration message associated with one or more LTM candidate NTN cells. The method may include initiating, after transmitting the RRC reconfiguration message, LTM using an indication to perform LTM.

Some aspects described herein relate to a non-transitory computer-readable medium that stores a set of instructions for wireless communication by a UE. The set of instructions, when executed by one or more processors of the UE, may cause the UE to receive an RRC reconfiguration message associated with one or more LTM candidate NTN cells. The set of instructions, when executed by one or more processors of the UE, may cause the UE to perform, after receiving the RRC reconfiguration message, LTM responsive to an indication to perform LTM.

Some aspects described herein relate to a non-transitory computer-readable medium that stores a set of instructions for wireless communication by a network node. The set of instructions, when executed by one or more processors of the network node, may cause the network node to transmit an RRC reconfiguration message associated with one or more LTM candidate NTN cells. The set of instructions, when executed by one or more processors of the network node, may cause the network node to initiate, after transmitting the RRC reconfiguration message, LTM using an indication to perform LTM.

Some aspects described herein relate to an apparatus for wireless communication. The apparatus may include means for receiving an RRC reconfiguration message associated with one or more LTM candidate NTN cells. The apparatus may include means for performing, after receiving the RRC reconfiguration message, LTM responsive to an indication to perform LTM.

Some aspects described herein relate to an apparatus for wireless communication. The apparatus may include means for transmitting an RRC reconfiguration message associated with one or more LTM candidate NTN cells. The apparatus may include means for initiating, after transmitting the RRC reconfiguration message, LTM using an indication to perform LTM.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram illustrating an example of a layer 1 or layer 2 (L1/L2) triggered mobility (LTM) procedure for terrestrial networks.

FIG. 4 is a diagram illustrating an example of an LTM dynamic switch.

FIG. 5 is a diagram illustrating an example of a regenerative satellite deployment and an example of a transparent satellite deployment in a non-terrestrial network (NTN).

FIG. 6 is a diagram illustrating an example of NTN handovers (HOs).

FIG. 7 is a diagram illustrating an example of fixed-cell HO.

FIG. 8 is a diagram illustrating an example of a moving cell generated by an orbiting satellite.

FIG. 9 is a diagram illustrating an example associated with LTM for NTNs.

FIG. 10 is a flowchart illustrating an example process performed, for example, at a UE or an apparatus of a UE that supports LTM for NTNs.

FIG. 11 is a flowchart illustrating an example process performed, for example, at a network node or an apparatus of a network node that supports LTM for NTNs.

FIG. 12 is a diagram of an example apparatus for wireless communication that supports LTM for NTNs.

FIG. 13 is a diagram of an example apparatus for wireless communication that supports LTM for NTNs.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Non-terrestrial networks (NTNs) involve larger handover (HO) delays and interruption times than terrestrial networks. For example, feeder link round trip times, the layer 3 (L3) signaling processing timeline, and random access channel (RACH)-based HOs can contribute to the large HO delays and interruption times. The large HO delay in NTNs can lead to radio link failures (RLFs). In fixed-cell scenarios, satellites overlap on the same area, during which time at least one user equipment (UE) (for example, a large number of UEs) can HO to a target cell, causing signaling overload. In moving-cell scenarios, satellite coverage can overlap and HO time is large, which can reduce robustness and lead to poor throughput. Furthermore, use of L3-based signaling for HOs in NTNs involves multiple configuration transmissions.

Various aspects relate generally to layer 1 or layer 2 (L1/L2) triggered mobility (LTM) for NTNs and to LTM execution for LTM candidate NTN cells. In some aspects, a network node may transmit, and a UE may receive, a radio resource control (RRC) reconfiguration message associated with one or more LTM candidate NTN cells. The RRC reconfiguration message may include one or more configuration identifiers, the one or more satellite identifiers, and/or one or more cell identifiers of the one or more LTM candidate NTN cells. If an LTM candidate NTN cell is associated with multiple beams, then the RRC reconfiguration message may include beam identifiers of the multiple beams. In some aspects, the network node may transmit, and the UE may receive, an indication to perform LTM. The UE may receive the indication to perform LTM after receiving the RRC reconfiguration message. The network node may initiate LTM using the indication to perform LTM (e.g., by transmitting the indication to perform LTM), and the UE may perform LTM responsive to the indication to perform LTM (e.g., in response to receiving the indication to perform LTM).

In some aspects, the UE may perform, responsive to the one or more LTM candidate NTN cells being within a range of the UE, one or more layer 1 (L1) measurements associated with the one or more LTM candidate NTN cells. For example, the UE may measure and/or report an upcoming LTM candidate NTN cell. The UE may perform the measurement and/or reporting in response to the UE satisfying a configured time, timer, or location and/or in response to L1/L2 signaling from the network.

In some aspects, the UE may transmit one or more L1 measurement reports associated with the one or more L1 measurements. For example, the UE may perform a measurement associated with a single upcoming LTM candidate NTN cell, and the L1 measurement report may contain a measurement associated with the LTM candidate NTN cell.

Particular aspects of the subject matter described in this disclosure can be implemented to realize one or more of the following potential advantages. In some examples, by transmitting or receiving the RRC reconfiguration message associated with one or more LTM candidate NTN cells and/or the indication to perform LTM, the described techniques can be used to reduce HO delay and/or interruption time. For example, the RRC reconfiguration message may enable the removal of a feeder link round-trip time, use of an L1/L2 signal processing timeline (which may be shorter than an L3 signal processing timeline), and RACH-free HO. In some examples, transmitting or receiving the RRC reconfiguration message associated with one or more LTM candidate NTN cells and/or the indication to perform LTM may improve robustness by reducing RLFs. For example, by reducing HO delay, implementations provided herein may avoid late-occurring HOs that cause RLFs. In some examples, transmitting or receiving the RRC reconfiguration message associated with one or more LTM candidate NTN cells and/or the indication to perform LTM may reduce an overlap time of satellites over the same area in fixed-cell scenarios. For example, the RRC reconfiguration message may enable UE staggering with greater timing precision (for example, due to use of L1/L2 signaling/measurements rather than L3 signaling/measurements). In some examples, transmitting or receiving the RRC reconfiguration message associated with one or more LTM candidate NTN cells and/or the indication to perform LTM may enable improved support for moving cell scenarios. For example, the RRC reconfiguration message may enable reduced coverage overlap among satellites and/or optimized HO time instances for improved robustness and throughput optimization. In some examples, transmitting or receiving the RRC reconfiguration message associated with one or more LTM candidate NTN cells and/or the indication to perform LTM may reduce signaling by providing and subsequently performing an LTM RRC configuration configured by the RRC reconfiguration message. Reducing the signaling may help to prevent signaling overload by avoiding HO of a large number of UEs from a source NTN cell to a target NTN cell. Transmitting or receiving the RRC reconfiguration message associated with one or more LTM candidate NTN cells and/or the indication to perform LTM may support intra-satellite HO and/or inter-satellite HO.

Performing, responsive to the one or more LTM candidate NTN cells being within a range of the UE, one or more L1 measurements associated with the one or more LTM candidate NTN cells may reduce signaling and resource consumption associated with measurement/reporting for an LTM candidate NTN cell. For example, due to the predictability of timing and/or location of NTN cells, the UE may perform measurement/reporting for an upcoming LTM candidate configured cell.

Transmitting the one or more L1 measurement reports associated with the one or more L1 measurements may reduce signaling associated with measurement reporting. For example, the L1 measurement report(s) may use a reduced reporting format (for example, with only one or two entries).

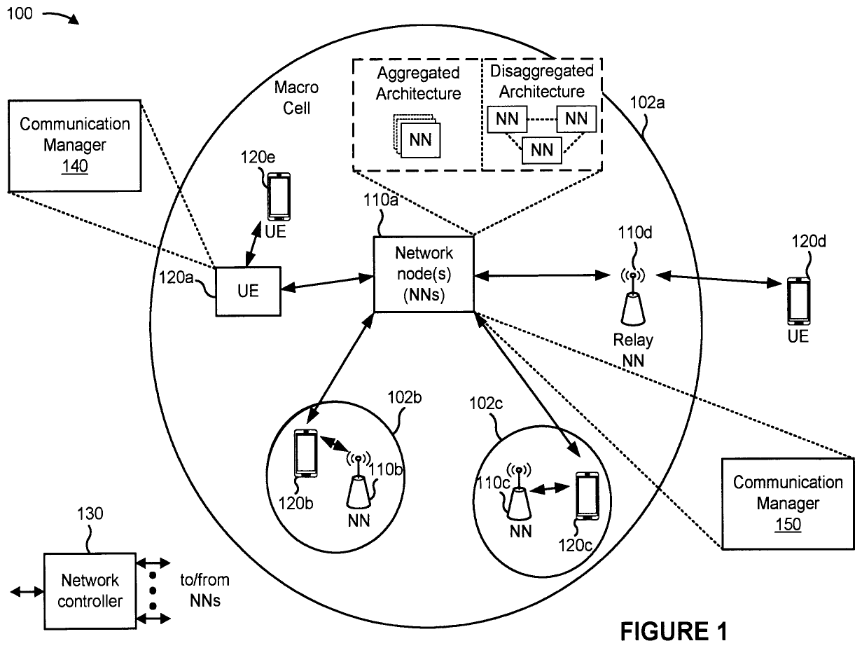

FIG. 1 is a diagram illustrating an example of a wireless network. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell 102a, a pico cell 102b, a femto cell 102c, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses (for example, an augmented reality (AR), virtual reality (VR), mixed reality, or extended reality (XR) headset), a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium. Some UEs 120 (for example, UEs 120a and 120e) may communicate directly using one or more sidelink channels (for example, without a network node as an intermediary to communicate with one another).

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol using for example a PC5 interface for direct communication, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110. In other examples, the two or more UEs 120 may communicate through a vehicle-to-network-vehicle (V2N2V) protocol for example by communicating through a Uu interface using the LTE and/or NR uplink and downlink.

In some aspects, the UE 120 may include a communication manager 140. As described in more detail elsewhere herein, the communication manager 140 may receive an RRC reconfiguration message associated with one or more LTM candidate NTN cells; and perform, after receiving the RRC reconfiguration message, LTM responsive to an indication to perform LTM. Additionally or alternatively, the communication manager 140 may perform one or more other operations described herein.

In some aspects, the network node 110 may include a communication manager 150. As described in more detail elsewhere herein, the communication manager 150 may transmit an RRC reconfiguration message associated with one or more LTM candidate NTN cells; and initiate, after transmitting the RRC reconfiguration message, LTM using an indication to perform LTM. Additionally or alternatively, the communication manager 150 may perform one or more other operations described herein.

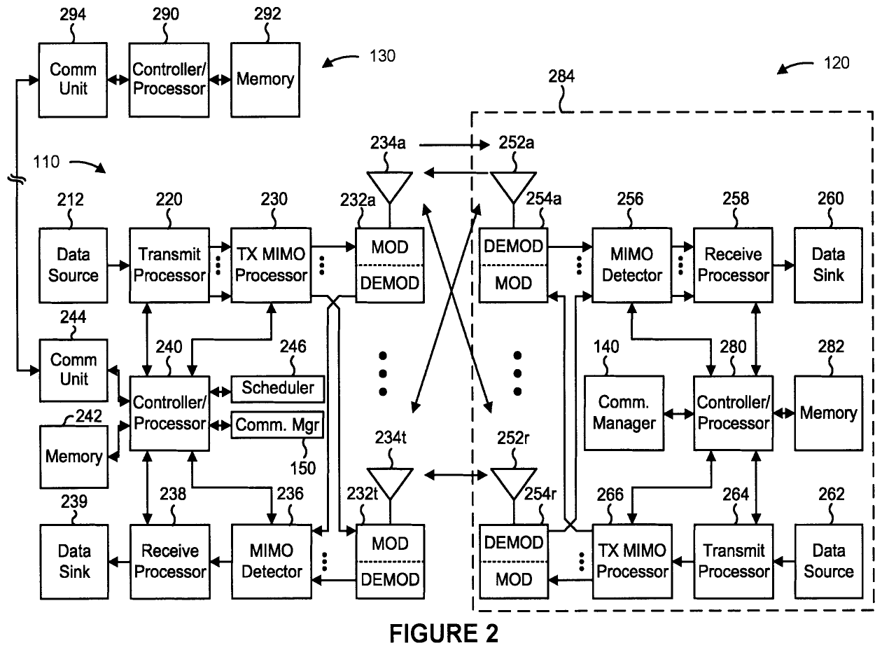

FIG. 2 is a diagram illustrating an example network node in communication with a UE in a wireless network. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 (for example, one or more memories) to perform aspects of any of the methods described herein.

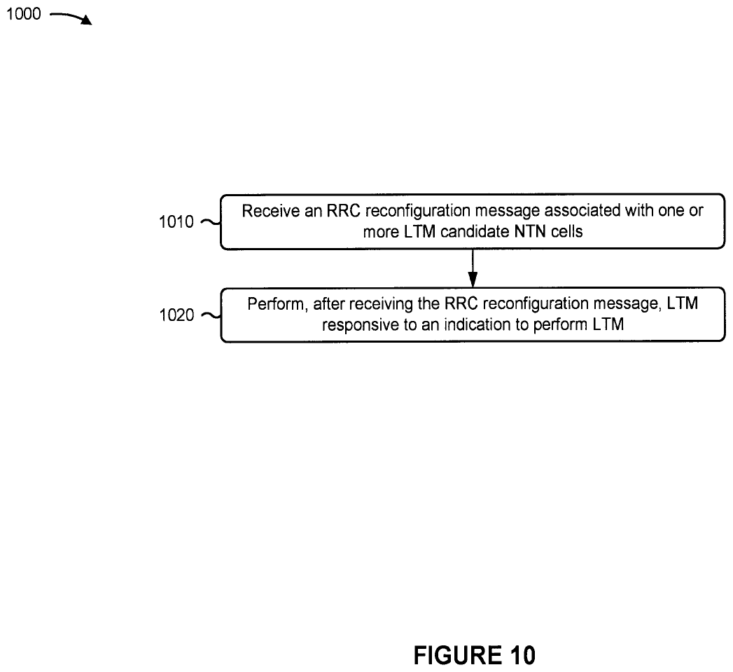

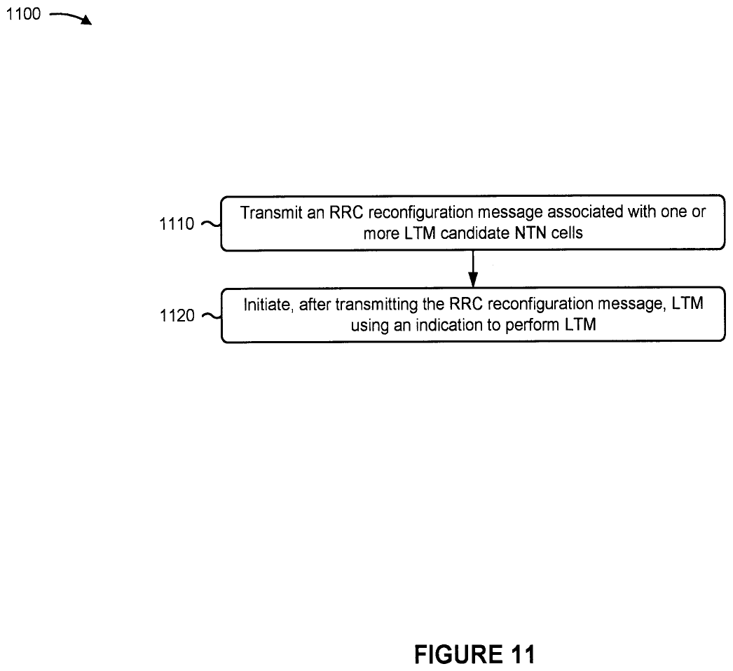

The controller/processor 240 of the network node 110, the controller/processor 280 of the UE 120, or any other component(s) of FIG. 2 may perform one or more techniques associated with LTM for NTNs, as described in more detail elsewhere herein. For example, the controller/processor 240 of the network node 110, the controller/processor 280 of the UE 120, or any other component(s) of FIG. 2 may perform or direct operations of, for example, process 1000 of FIG. 10, process 1100 of FIG. 11, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10, process 1100 of FIG. 11, or other processes as described herein. In some examples, executing instructions may include running the instructions, converting the instructions, compiling the instructions, or interpreting the instructions, among other examples. In some implementations, one or more of the multiple memories may be configured to store processor-executable code that, when executed, may configure the one or more processors to perform various functions described herein (as part of a processing system). In some other implementations, the processing system may be pre-configured to perform various functions described herein.

In some aspects, an individual processor may perform all of the functions described as being performed by one or more processors. In some aspects, one or more processors may collectively perform (or be configured or operable to perform) a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

In some aspects, the UE 120 includes means for receiving an RRC reconfiguration message associated with one or more LTM candidate NTN cells; and/or means for performing, after receiving the RRC reconfiguration message, LTM responsive to an indication to perform LTM. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an RRC reconfiguration message associated with one or more LTM candidate NTN cells; and/or means for initiating, after transmitting the RRC reconfiguration message, LTM using an indication to perform LTM. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

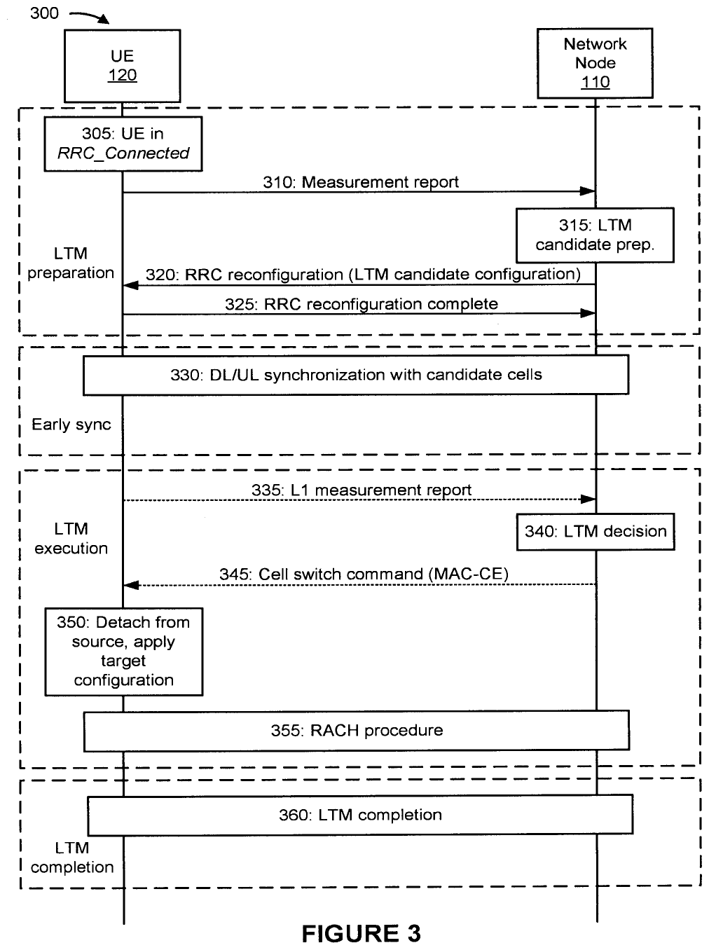

FIG. 3 is a diagram illustrating an example 300 of an LTM procedure for terrestrial networks, in accordance with the present disclosure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). The network node 110 may instruct the UE 120 to change cells using an L3 handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (for example, measurements associated with the source cell and one or more neighboring cells). In response to receiving the RRC reconfiguration message, the UE 120 may communicate with the source cell and the target cell to detach from the source cell and connect to the target cell (for example, the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some examples, a UE 120 may be configured to perform a lower-layer (for example, L1 and/or L2) handover procedure, sometimes referred to an LTM procedure, such as the example 300 LTM procedure shown in FIG. 3. As shown in FIG. 3, the LTM procedure may include four phases: an LTM preparation phase, an early synchronization phase (shown as “early sync” in FIG. 3), an LTM execution phase, and/or an LTM completion phase.

During the LTM preparation phase, and in a first operation 305, the UE 120 may be in an RRC connected state (sometimes referred to as RRC_Connected) with a source cell. In a second operation 310, the UE 120 may transmit, and the network node 110 may receive, a measurement report (sometimes referred to as a MeasurementReport), which may be an L3 measurement report. The measurement report may indicate signal strength measurements (for example, RSRP, RSSI, RSRQ, and/or CQI) or similar measurements associated with the source cell and/or one or more neighboring cells. In some examples, based at least in part on the measurement report or other information, the network node 110 may decide to use LTM, and thus, in a third operation 315, the network node 110 may initiate LTM candidate preparation.

In a fourth operation 320, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE and/or cells for which the UE 120 may later be triggered to perform an LTM procedure. In a fifth operation 325, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and in a sixth operation 330, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with the seventh operation 335). In some aspects, performing the early synchronization with the one or more candidate cells may reduce latency associated with performing a RACH procedure later in the LTM procedure, which is described in more detail below in connection with the seventh operation 355.

During the LTM execution phase, and in a seventh operation 335, the UE 120 may perform L1 measurements on the configured LTM candidate target cells, and thus may transmit, to the network node 110, lower-layer (for example, L1) measurement reports. In an eighth operation 340, based at least in part on the lower-layer measurement reports, the network node 110 may decide to perform an LTM cell switch to a target cell. Accordingly, in a ninth operation 345, the network node 110 may transmit, and the UE 120 may receive, a MAC control element (MAC-CE) or similar message triggering an LTM cell switch (the MAC-CE or similar message is sometimes referred to herein as a cell switch command). The cell switch command may include an indication of a candidate configuration index associated with the target cell. In a tenth operation 350, based at least in part on receiving the cell switch command, the UE 120 may switch to the configuration of the LTM candidate target cell (for example, the UE 120 may detach from the source cell and apply the target cell configuration). Moreover, in an eleventh operation 355, the UE 120 may perform a RACH procedure towards the target cell, such as when a timing advance associated with the target cell is not available (for example, in examples in which the UE 120 did not perform the early synchronization as described above in connection with the sixth operation 330).

During the LTM completion phase, and in a twelfth operation 360, the UE 120 may indicate successful completion of the LTM cell switch towards the target cell. In this way, cell switch to a target cell may be performed using less overhead than for an L3 handover procedure and/or a cell switch to a target cell may be associated with reduced latency as compared to L3 handover procedure.

As indicated above, FIG. 3 is provided as an example. Other examples may differ from what is described with respect to FIG. 3.

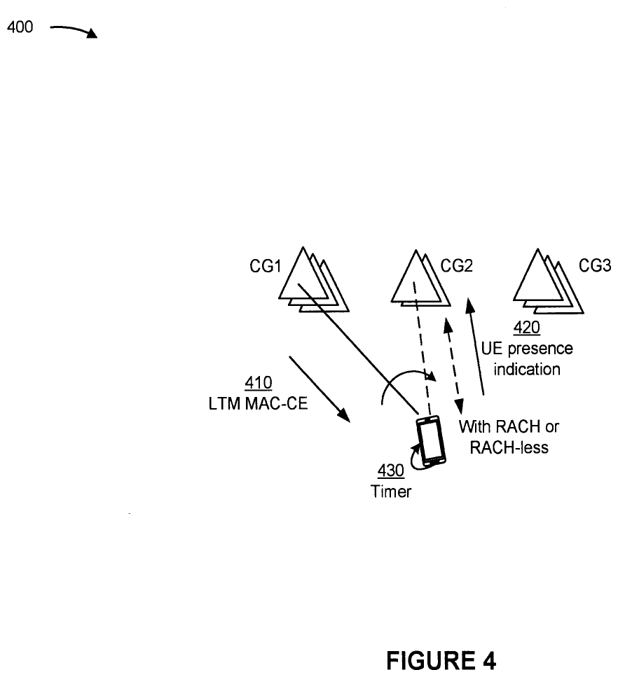

FIG. 4 is a diagram illustrating an example 400 of an LTM dynamic switch, in accordance with the present disclosure. Example 400 includes a UE and three cell groups (CGs): CG1, CG2, and CG3.

Initially, the UE is initially connected to a source cell that belongs to CG1. In a first operation 410, the UE may receive a MAC-CE indicating that the UE is to switch to CG2 (for example, a cell switch command). The MAC-CE may convey L1/L2 mobility trigger information, such as a candidate configuration index, transmission configuration indication (TCI) state, or timing adjustment/advance (TA), among other examples. For example, the TA may be provided in the MAC-CE cell switch command.

A timing advance parameter (T_{TA}) may represent an offset between the start of a received downlink frame and the start of a transmitted uplink frame. In some examples, T_{TA}=(N_{TA}+N_{TA,UE-specific}+N_{TC,common}+N_{TA,offset})T_{c}, where N_{TA} is defined as zero for physical random access channel (PRACH) and is updated based on a TA command field in a msg2/msgB and a MAC-CE TA command, N_{TA,UE-specific} is a UE self-estimated TA that pre-compensates for service link delay, N_{TA,common} is network-controlled common TA that compensates for feeder link delay between the satellite and a reference point, and N_{TA,offset} is a fixed offset. N_{TA} may be cell-specific. In some examples, the network may indicate whether N_{TA} for the target cell is identical to the source cell. In some examples, the network may explicitly provide N_{TA}.

In a second operation 420, the UE may indicate a presence of the UE to CG2 and switch to CG2. For example, the UE may indicate an arrival of the UE in the target cell of CG2.

Both RACH-based and RACH-less procedures for the L1/L2 mobility switch may be supported. The L1/L2 mobility switch may involve a RACH-less procedure if the UE does not need to acquire the TA during the cell switch. In the case of a RACH-based procedure, a RACH resource for contention-free random access (CFRA) for the L1/L2 dynamic switch may be provided in an RRC configuration. In some examples, the UE may transmit only msg1 of a RACH procedure.

The LTM cell switch may be supervised by a timer 430 (for example, a T-304-like timer). The LTM switch may be intra-DU or inter-DU. In the case of inter-DU LTM, the connection between the source DU and the target DU may be through the (non-ideal) backhaul.

As indicated above, FIG. 4 is provided as an example. Other examples may differ from what is described with respect to FIG. 4.

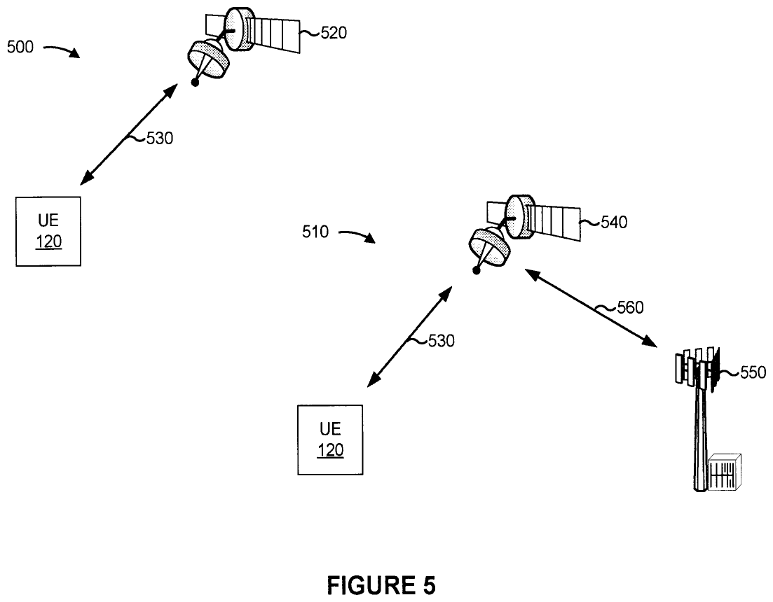

FIG. 5 is a diagram illustrating an example 500 of a regenerative satellite deployment and an example 510 of a transparent satellite deployment in a non-terrestrial network.

Example 500 shows a regenerative satellite deployment. In example 500, a UE 120 is served by a satellite 520 via a service link 530. For example, the satellite 520 may include a network node 110 (for example, network node 110a) or a gNB. In some aspects, the satellite 520 may be referred to as a non-terrestrial base station, a regenerative repeater, or an on-board processing repeater. In some aspects, the satellite 520 may demodulate an uplink radio frequency signal, and may modulate a baseband signal derived from the uplink radio signal to produce a downlink radio frequency transmission. The satellite 520 may transmit the downlink radio frequency signal on the service link 530. The satellite 520 may provide a cell that covers the UE 120.

Example 510 shows a transparent satellite deployment, which may also be referred to as a bent-pipe satellite deployment. In example 510, a UE 120 is served by a satellite 540 via the service link 530. The satellite 540 may be a transparent satellite. The satellite 540 may relay a signal received from gateway 550 via a feeder link 560. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 530 to a frequency of the uplink radio frequency transmission on the feeder link 560, and may amplify and/or filter the uplink radio frequency transmission. In some aspects, the UEs 120 shown in example 500 and example 510 may be associated with a Global Navigation Satellite System (GNSS) capability or a Global Positioning System (GPS) capability, though not all UEs have such capabilities. The satellite 540 may provide a cell that covers the UE 120.

As indicated above, FIG. 5 is provided as an example. Other examples may differ from what is described with regard to FIG. 5.

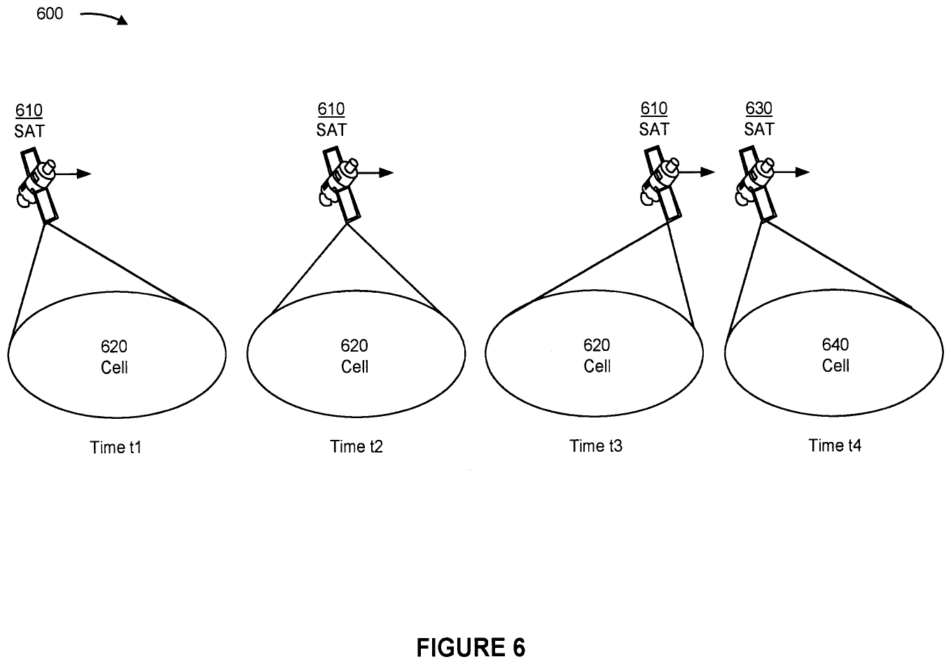

FIG. 6 is a diagram illustrating an example 600 of NTN handovers (HOs), in accordance with the present disclosure. Example 600 illustrates four times: t1, t2, t3, and t4. At times t1-t3, a satellite 610 provides a cell 620 as the satellite 610 orbits the earth. At time t4, a satellite 630 provides a cell 640 as the satellite 630 orbits the earth. Communications with satellites 610 and 630 may involve larger over the air (OTA) delays than those associated with terrestrial networks.

Satellites 610 and 630 may be geostationary earth orbit (GEO) satellites or low earth orbit (LEO) satellites. GEO satellites may provide earth-fixed cells, and LEO satellites may provide quasi-earth-fixed cells (for example, using steerable beams) and/or earth-moving cells (for example, where the beams move with the satellite).

For a GEO satellite orbiting at a height of 36,000 km and a LEO satellite orbiting at a height of 600 km, the GEO satellite may have a negligible relative speed with respect to the earth, and a LEO satellite may have a relative speed with respect to the earth of approximately 7.56 km/s. The GEO satellite or a LEO satellite may have a minimum elevation for both feeder and service links of 10°. The GEO satellite may have a typical beam footprint diameter of 100-3500 km (for example, 200-3500 km) and the LEO satellite may have a typical beam footprint diameter of 50-1000 km (for example, 100-1000 km).

A propagation delay contribution to the round trip delay on the radio interface between the gNB and the UE may be 477.48-541.46 ms for the GEO satellite may and 8-25.77 ms for the LEO satellite (for a LEO satellite orbiting at a height of 1200 km, the propagation delay contribution to the round trip delay on the radio interface between the gNB and the UE may be approximately 41.77 ms). A maximum delay variation experienced by the UE may be negligible for the GEO satellite and ±40 μs/sec for the LEO satellite. The ±40 μs/sec maximum delay variation for the LEO satellite may be 17% of the cyclic prefix for 15 kHz subcarrier spacing.

The GEO satellite may have a maximum differential delay within a cell of 10.3 ms and the LEO satellite may have a maximum differential delay within a cell of 3.12 ms. The maximum Doppler shift experienced by an earth-fixed UE may be 0.93 ppm (at 2 GHz with a 1.9 kHz carrier frequency offset) for the GEO satellite and 24 ppm (at 2 GHz with a 48 kHz carrier frequency offset) for the LEO satellite.

Both the GEO satellite and the LEO satellite may be associated with a delay spread in satellite propagation channels. The S-band (2-4 GHz) may, for an elevation range of 15-55°, be associated with a delay spread of 250 ns (which may be approximately equal to 8 sampling times (Ts) for a 15 kHz subcarrier spacing). The Ka-band (26.5-40 GHz) may be associated with a delay spread of 25 ns (which may be equal to 6.2 Ts, or 4.07 ns, for a 15 kHz subcarrier spacing) for omnidirectional antennas and 0 ns for directional antennas.

A UE in the geographic area may perform a HO (for example, L3 HO) procedure from the cell 620 to the cell 640. The HO may be a command-based HO or a conditional HO (CHO). Due to the deterministic nature of the constellation/movement of the satellites 610 and 630, the HO may be predicable. The HO may be RACH-based or RACH-less. For example, the UE may determine the TA without RACH based on system information (SI) (for example, system information block (SIB) 19 (SIB19)). A CHO may be performed with RACH.

As indicated above, FIG. 6 is provided as an example. Other examples may differ from what is described with respect to FIG. 6.

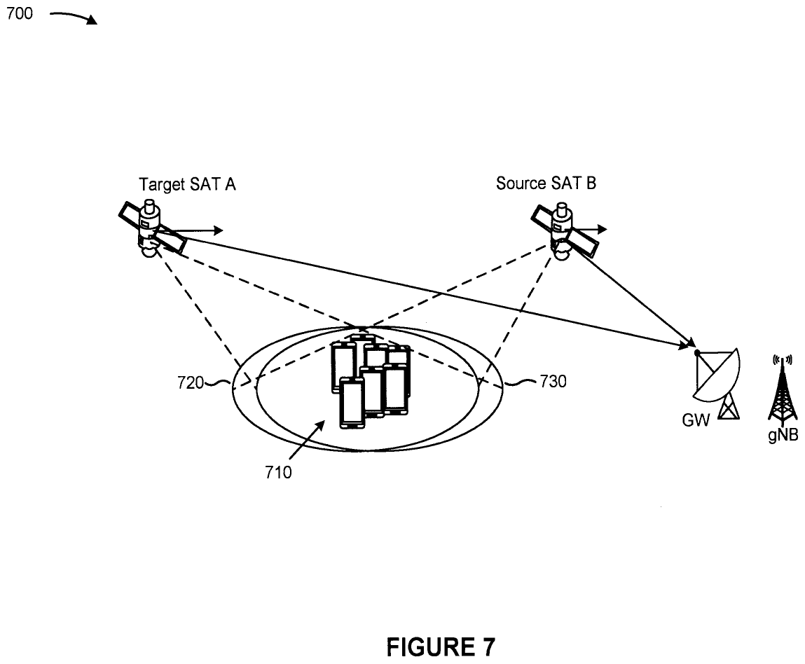

FIG. 7 is a diagram illustrating an example 700 of fixed-cell HO, in accordance with the present disclosure. As shown, UEs 710 may switch from an old (for example, source) cell 720 to a new (for example, target) cell 730 in a fixed-cell scenario. In a fixed-cell scenario, a satellite cell remains fixed with respect to a geographic area for a duration of time. In some examples, the switch may be a soft switch, whereby, for a short period of time, the old cell 720 and the new cell 730 overlap. In some examples, the switch may be a hard switch, whereby the old cell 720 is turned off and the new cell 730 is turned on (for example, the old cell 720 and the new cell 730 do not overlap).

HO of a large number of UEs (for example, UEs 710) from the old cell 720 to the new cell 730 may cause signaling overload. To avoid HO, the old cell 720 and the new cell 730 may be the same cell (for example, the old cell 720 and the new cell 730 may have the same cell identifier, SIB, feeder link, or UE configuration, among other examples). However, the satellite information would still be different in this case, and different synchronization signal blocks (SSBs) may experience different delays and be associated with different assistance information, which may impact the behavior of the UEs 710 while the two SSBs coexist.

As indicated above, FIG. 7 is provided as an example. Other examples may differ from what is described with respect to FIG. 7.

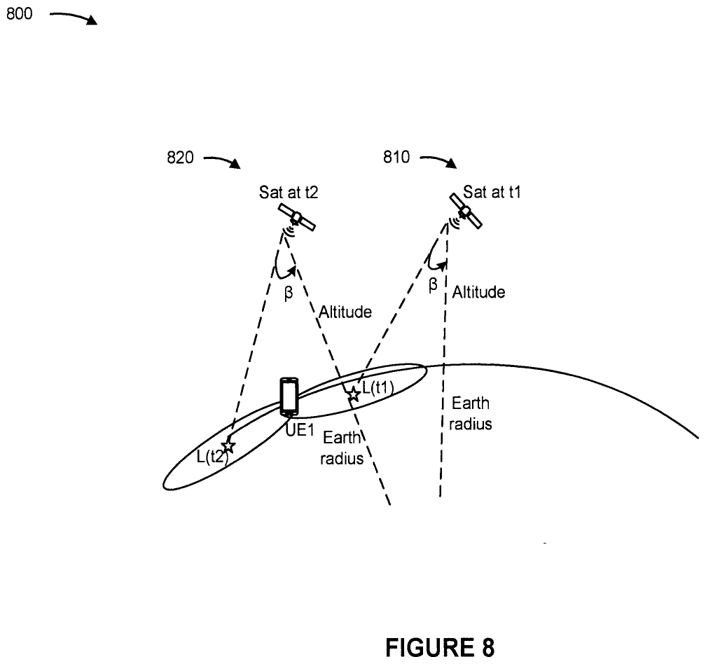

FIG. 8 is a diagram illustrating an example 800 of a moving cell generated by an orbiting satellite, in accordance with the present disclosure.

As shown, the moving cell may be associated with a reference location L. In a first operation 810, at time t1, the satellite and reference location L are positioned at first locations. In a second operation 820, at time t2, the cell is the satellite and reference location L are positioned at second locations.

Thus, the moving cell moves relative to the earth. The reference location L and a distance threshold (for example, a configured distance threshold, such as a radius) for the moving cell may be broadcast. A UE may initiate measurements when the location of the UE relative to the reference location L is larger than the configured distance threshold.

In some examples, the reference location L is time-variant. In some examples, the satellite may not have a steerable beam. One or more information elements (IEs) may be re-used for broadcasting the reference location L and/or the distance threshold. Additionally or alternatively, time information (for example, how the reference location moves over time or how to derive the reference location from an epoch time) may be provided.

As indicated above, FIG. 8 is provided as an example. Other examples may differ from what is described with respect to FIG. 8.

NTNs involve larger HO delays and interruption times than terrestrial networks. For example, feeder link round trip times, the L3 signaling processing timeline, and RACH-based HOs can contribute to the large HO delays and interruption times. The large HO delay in NTNs can lead to RLFs. In fixed-cell scenarios, satellites overlap on the same area, during which time a large number of UEs can HO to a target cell, causing signaling overload. In moving-cell scenarios, satellite coverage can overlap and HO time is large, which can reduce robustness and lead to poor throughput. Furthermore, use of L3-based signaling for HOs in NTNs involves multiple configuration transmissions.

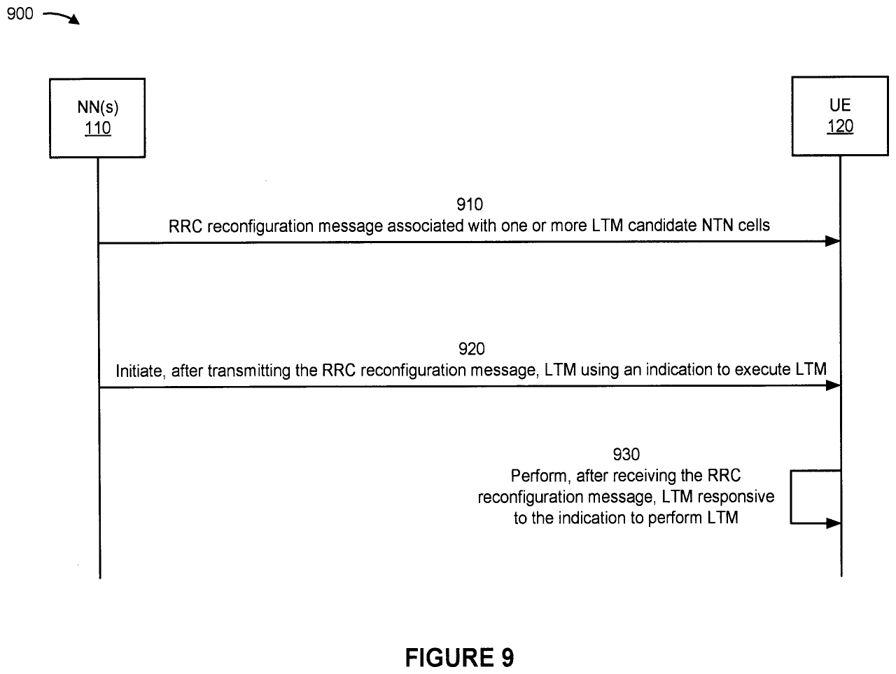

FIG. 9 is a diagram illustrating an example 900 associated with LTM for NTNs, in accordance with the present disclosure. As shown in FIG. 9, a network node 110 (for example, an NTN node) and a UE 120 (for example, an NTN UE) may communicate with one another.

In a first operation 910, the network node 110 may transmit, and the UE 120 may receive, an RRC reconfiguration message associated with one or more LTM candidate NTN cells. The RRC reconfiguration message may configure LTM for the UE 120. In some aspects, the RRC reconfiguration message may include one or more satellite identifiers associated with the one or more LTM candidate NTN cells. For example, the RRC reconfiguration message may include one or more configuration identifiers, the one or more satellite identifiers, and/or one or more cell identifiers of the one or more LTM candidate NTN cells. In some examples, the RRC reconfiguration message may include a list of cells that are associated with the same satellite. In some examples, if an LTM candidate NTN cell is associated with multiple beams, then the RRC reconfiguration message may include beam identifiers of the multiple beams.

In some aspects, the UE 120 may perform, responsive to the one or more LTM candidate NTN cells being within a range of the UE, one or more L1 measurements associated with the one or more LTM candidate NTN cells. For example, the network node 110 may configure the UE 120 with a measurement and reporting configuration, and the UE 120 may perform activation-based L1-based measurement and reporting for the LTM candidate NTN cells. For example, the UE 120 may measure and/or report an LTM candidate NTN cell that is upcoming. The UE 120 may perform the measurement and/or reporting in response to the UE 120 satisfying a configured time, timer, or location and/or in response to L1/L2 signaling from the network.

In some aspects, the UE 120 may transmit one or more L1 measurement reports associated with the one or more L1 measurements. For example, the UE 120 may perform a measurement associated with a single upcoming LTM candidate NTN cell, and the L1 measurement report may contain a measurement associated with the LTM candidate NTN cell. In some aspects, the L1 measurement report may not contain a cell identifier associated with the single LTM candidate NTN cell. The measurement report may be downlink control information (DCI)-based or MAC-CE-based.

In some aspects, the UE 120 may perform the one or more L1 measurements responsive to a current time or UE location (e.g., a current location of the UE), and the UE 120 may transmit the one or more L1 measurement reports responsive to the one or more L1 measurements satisfying a measurement threshold (e.g., a signal strength threshold or the like). In some examples, the UE 120 may perform trigger-based L1 measurement reporting using a threshold configured via RRC, and the measurement reporting may be performed in conjunction with a time or location condition (for example, the UE 120 may start measuring a cell upon reaching a certain time or location and may report the measurement once the measurement satisfies the threshold).

The one or more LTM candidate NTN cells may be configured for multiple sequential HOs with the RRC reconfiguration message. For example, the RRC reconfiguration message may include a list of configuration identifiers, and the UE 120 may perform multiple sequential HOs to the LTM candidate NTN cells using the list of configuration identifiers. The RRC reconfiguration message may implicitly or explicitly indicate the order of execution of the HOs. The RRC reconfiguration message may implicitly indicate the order of execution of the HOs in examples where only one suitable LTM candidate NTN cell is upcoming for the UE 120 at any given time. The RRC reconfiguration message may explicitly indicate the order of execution of the HOs in examples where multiple suitable LTM candidate NTN cells are upcoming for the UE 120 at any given time.

Examples of implicit indications are provided as follows. In some aspects, the RRC reconfiguration message may include a plurality of configuration identifiers associated with a plurality of LTM candidate NTN cells (including the one or more LTM candidate NTN cells), and the UE 120 may perform LTM responsive to an order associated with the plurality of configuration identifiers. For example, the order may be an increasing order of the configuration identifiers, or the order may be an ordered list of the configuration identifiers in the RRC reconfiguration message. In some aspects, the UE 120 may perform LTM responsive to a location of the UE 120 or a current time. For example, the UE 120 may determine that the UE 120 is within a range of one of the LTM candidate NTN cells using a location of the UE 120 and/or a current time (for example, using information regarding the orbit(s) of one or more satellites that provide the LTM candidate NTN cells).

Examples of explicit indications are provided as follows. In some aspects, the RRC reconfiguration message indicates a plurality of groups associated with a plurality of LTM candidate NTN cells including the one or more LTM candidate NTN cells. For example, the RRC reconfiguration message may explicitly signal a plurality of configuration identifier groups, each to be considered in a subsequent LTM execution, and the network node 110 may transmit, and the UE 120 may receive, an L1/L2 LTM switch command that points to a configuration identifier of the applicable configuration identifier group. In some examples, the network node 110 may explicitly signal a configuration identifier group (for example, a subset of configuration identifiers), and the UE 120 may perform measurement and reporting for each LTM candidate NTN cell in the group.

In a second operation 920, the network node 110 may initiate, after transmitting the RRC reconfiguration message, LTM using an indication to execute LTM. For example, the network node 110 may transmit, and the UE 120 may receive, after transmitting or receiving the RRC reconfiguration message, the indication to perform LTM. The indication to perform LTM may prompt the UE 120 to perform LTM to one of the one or more LTM candidate NTN cells. In some aspects, the indication to perform LTM may be specific to the UE 120. For example, the indication to perform LTM may be a per-UE L1/L2 signal to perform LTM (for example, an LTM switch). In some aspects, the indication to perform LTM may be associated with a plurality of UEs including the UE 120. For example, the indication to perform LTM may be an L1/L2 signaling-based group LTM command (for example, an LTM switch command for a group of UEs that perform LTM upon receiving the command).

In some aspects where the indication to perform LTM is specific to the UE 120, the indication to perform LTM may include a payload that contains at least one of: one or more configuration identifiers associated with the one or more LTM candidate NTN cells, one or more TA parameters (for example, N_{TA}) associated with the one or more LTM candidate NTN cells, or one or more beam identifiers associated with the one or more LTM candidate NTN cells. For example, the payload of the indication to perform LTM may optionally include a configuration identifier (for example, present only if LTM is not performed in a specified order), an N_{TA} parameter (for example, present only if non-zero), and/or a beam identifier (for example, present only if multiple beams are configured per LTM candidate NTN cell).

The indication to perform LTM specific to the UE 120 may be DCI-based or MAC-CE-based. A DCI-based indication may have an acknowledgement for reliability and may be used to carry an amount of information that is less than the amount of information carried for a terrestrial network. For example, a bit-trigger may be sufficient in examples where only one target cell/beam is applicable and the N_{TA} is the same. A MAC-CE-based indication may carry different information than a MAC-CE-based indication that is used in a terrestrial network.

In some aspects where the indication to perform LTM is associated with the plurality of UEs, the RRC reconfiguration message may indicate a group identifier associated with the plurality of UEs. For example, the group associated with the group identifier may be defined using the RRC reconfiguration message. For example, each UE (for example, including the UE 120) in the group may be configured with the group identifier.

In some aspects where the indication to perform LTM is associated with the plurality of UEs, the indication to perform LTM may indicate a group identifier associated with the plurality of UEs. In some aspects, the indication to perform LTM may explicitly indicate a group identifier or indicate a bitmap associated with the group identifier. For example, the L1/L2 signaling content of the indication to perform LTM may explicitly indicate the group identifier to perform LTM (e.g., the indication to perform LTM may indicate a number corresponding to the group identifier) or may indicate a bitmap correlated with a group identifier. The plurality of UEs may be configured to perform LTM using respective LTM configurations (e.g., associated with one or more RRC reconfiguration messages). For example, each UE (for example, UE 120) in a group associated with the group identifier may perform LTM using the LTM configurations for that UE. The indication to perform LTM may include additional information (for example, N_{TA} or beam identifier, among other examples). The indication to perform LTM may use DCI (for example, with an explicit acknowledgment for reliability) or MAC-CE (for example, with a specific logical channel identifier).

In a third operation 930, the UE 120 may perform (e.g., execute), after receiving the RRC reconfiguration message, LTM responsive to the indication to perform LTM. For example, the UE 120 may switch from a current serving cell of the network node 110 to one of the LTM candidate NTN cells.

Initiating and/or performing LTM as discussed above in connection with FIG. 9, may reduce HO delay and/or interruption time. For example, the RRC reconfiguration message may enable the removal of a feeder link round-trip time, use of an L1/L2 signal processing timeline (which may be shorter than an L3 signal processing timeline), and RACH-free HO.

Additionally or alternatively, initiating and/or performing LTM may improve robustness by reducing RLFs. For example, by reducing HO delay, implementations provided herein may avoid late-occurring HOs that cause RLFs. LTM may reduce delays/interruptions more than CHOs (which may improve robustness more than baseline L3 HOs) due to RACH-less operation (CHO involves RACH) and feeder link round-trip time elimination. For example, the RRC configuration message may enable the UE 120 to avoid experiencing a radio link failure, where the UE 120 would have otherwise experienced a radio link failure (for example, in an example of a CHO with a reduced overlap duration (for example, due to interference) that results in insufficient time for measurement and timely L3 signaling).

Additionally or alternatively, initiating and/or performing LTM may reduce an overlap time of satellites over the same area in fixed-cell scenarios. For example, the RRC reconfiguration message may enable UE staggering with greater timing precision (for example, due to use of L1/L2 signaling/measurements rather than L3 signaling/measurements).

Additionally or alternatively, initiating and/or performing LTM may enable improved support for moving cell scenarios. For example, the RRC reconfiguration message may enable reduced coverage overlap among satellites and/or optimized HO time instances for improved robustness and throughput optimization.

Additionally or alternatively, initiating and/or performing LTM may reduce signaling by providing and subsequently performing an LTM RRC configuration (for example, configured by the RRC reconfiguration message). Reducing the signaling may help to prevent signaling overload by avoiding HO of a large number of UEs from a source NTN cell to a target NTN cell.

Additionally or alternatively, initiating and/or performing LTM may enable intra-satellite HO and/or inter-satellite HO. With respect to intra-satellite HO, NTN systems (for example, as specified in future 6G related standards of 3GPP) may include RAN protocol layers on the satellites (for example, as opposed to a bent-pipe scenario), and L2 being on the satellite may enable efficient utilization of lower layer mobility (for example, LTM), thereby enabling fast HOs within NTN cells. The HO delay/interruption may be reduced due to the lower layer signaling as well as removal of the round-trip time delay on the feeder link. For example, the HO LTM decision/execution may be performed at the satellite as opposed to a ground network, which controls L3 handover.

With respect to inter-satellite HO, NTN systems may support inter-satellite communication links (for example, in addition to supporting RAN protocol layers on the satellite), which may enable efficient utilization of LTM such that inter-satellite HOs can be performed by lower layer mobility procedures (for example, without involving the ground network). For example, in addition to reducing delays compared to L3 processing, L2 processing may also enable the feeder link round trip time to be eliminated.

Implementations described herein may enable LTM on legacy satellites that use bent-pipe configurations and, thus, feeder links; however, LTM can nonetheless provide certain benefits, described above, to legacy satellites.

The RRC reconfiguration message including one or more satellite identifiers associated with the one or more LTM candidate NTN cells may enable the UE 120 to identify one or more satellites using the satellite identifier(s).

Performing, responsive to the one or more LTM candidate NTN cells being within a range of the UE, one or more L1 measurements associated with the one or more LTM candidate NTN cells may reduce signaling and resource consumption associated with measurement/reporting for an LTM candidate configured cell (for example, an LTM candidate NTN cell). For example, due to the predictability of timing and/or location of NTN cells, the UE 120 may perform measurement/reporting for an LTM candidate configured cell that is upcoming. For example, the UE 120 may perform measurement/reporting for the upcoming LTM candidate configured cell instead of performing measurement/reporting for all LTM candidate configured cells (for example, as the UE 120 would in a terrestrial network), as many of the LTM candidate configured cells may not be detectable by the UE 120. The LTM candidate configured cells that are not detectable by the UE 120 may be configured for purposes of subsequent LTM (for example, without subsequent reconfiguration). Moreover, unlike in terrestrial networks, implementations described herein may not involve LTM TCI configurations with unified TCI or RACH configurations for early RACH.

Transmitting the one or more L1 measurement reports associated with the one or more L1 measurements may reduce signaling associated with measurement reporting. For example, the L1 measurement report(s) may use a reduced reporting format (for example, with only one or two entries).

The L1 measurement report not containing a cell identifier associated with the single LTM candidate NTN cell may reduce signaling associated with the L1 measurement report. For example, the L1 measurement report may, unlike in terrestrial networks, eliminate information associated with the cell identifier. The L1 measurement report may not include the cell identifier because the UE 120 and the satellite may determine the cell that is being measured (for example, due to the predictability of the location and/or timing of NTN cells). A DCI-based L1 measurement report may be transmitted earlier, and carry less information, than a MAC-CE-based L1 measurement report. A MAC-CE-based L1 measurement report may include additional information, such as TA or channel quality indicator (CQI) information, among other examples. The MAC-CE-based report may be transmitted within a relaxed timeline, which may be acceptable due to the relatively large OTA delays associated with NTNs.

Implicitly indicating the order of LTM execution (for example, performing LTM responsive to an order associated with the plurality of configuration identifiers and/or performing LTM responsive to a location of the UE 120 or a current time) may reduce signaling overhead. Explicitly indicating the order of LTM execution (for example, the RRC reconfiguration message indicating the plurality of groups associated with the plurality of LTM candidate NTN cells) may reduce signaling space relative to terrestrial networks, where the configuration identifier is signaled in the LTM switch command without grouping. For example, due to the predictability of the location and/or timing of NTN cells, implementations provided herein may enable only the configuration identifiers from one group to be addressed (for example, as opposed to addressing all LTM candidate configuration identifiers for subsequent LTM execution).

The indication to perform LTM being associated with a plurality of UEs may enable a large number of UEs to perform HOs within the same time window. For example, unlike in terrestrial networks, where no group LTM is defined, the plurality of UEs may HO from a source NTN cell to a target NTN cell.

As indicated above, FIG. 9 is provided as an example. Other examples may differ from what is described with respect to FIG. 9.

FIG. 10 is a flowchart illustrating an example process 1000 performed, for example, at a UE or an apparatus of a UE that supports LTM for NTNs in accordance with the present disclosure. Example process 1000 is an example where the apparatus or the UE (for example, UE 120) performs operations associated with LTM for NTNs.

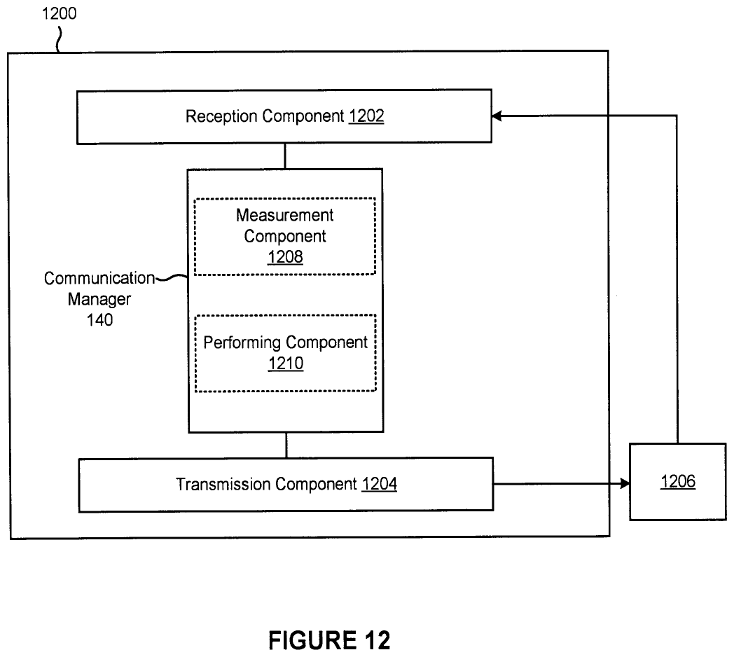

As shown in FIG. 10, in some aspects, process 1000 may include receiving an RRC reconfiguration message associated with one or more LTM candidate NTN cells (block 1010). For example, the UE (such as by using communication manager 140 or reception component 1202, depicted in FIG. 12) may receive an RRC reconfiguration message associated with one or more LTM candidate NTN cells, as described above.

As further shown in FIG. 10, in some aspects, process 1000 may include performing, after receiving the RRC reconfiguration message, LTM responsive to an indication to perform LTM (block 1020). For example, the UE (such as by using communication manager 140, depicted in FIG. 12) may perform, after receiving the RRC reconfiguration message, LTM responsive to an an indication to perform LTM, as described above.

Process 1000 may include additional aspects, such as any single aspect or any combination of aspects described below or in connection with one or more other processes described elsewhere herein.

In a first additional aspect, the RRC reconfiguration message includes one or more satellite identifiers associated with the one or more LTM candidate NTN cells.

In a second additional aspect, alone or in combination with the first aspect, process 1000 includes performing, responsive to the one or more LTM candidate NTN cells being within a range of the UE, one or more L1 measurements associated with the one or more LTM candidate NTN cells, and transmitting one or more L1 measurement reports associated with the one or more L1 measurements.

In a third additional aspect, alone or in combination with one or more of the first and second aspects, performing the one or more L1 measurements includes performing the one or more L1 measurements responsive to a current time or UE location, and transmitting the one or more L1 measurement reports includes transmitting the one or more L1 measurement reports responsive to the one or more L1 measurements satisfying a measurement threshold.

In a fourth additional aspect, alone or in combination with one or more of the first through third aspects, the one or more LTM candidate NTN cells are a single LTM candidate NTN cell, the one or more L1 measurement reports are a single L1 measurement report, and the single L1 measurement report does not contain a cell identifier associated with the single LTM candidate NTN cell.

In a fifth additional aspect, alone or in combination with one or more of the first through fourth aspects, the RRC reconfiguration message includes a plurality of configuration identifiers associated with a plurality of LTM candidate NTN cells including the one or more LTM candidate NTN cells, and performing LTM includes performing LTM responsive to an order associated with the plurality of configuration identifiers.

In a sixth additional aspect, alone or in combination with one or more of the first through fifth aspects, performing LTM includes performing LTM responsive to a location of the UE or a current time.

In a seventh additional aspect, alone or in combination with one or more of the first through sixth aspects, the RRC reconfiguration message indicates a plurality of groups associated with a plurality of LTM candidate NTN cells including the one or more LTM candidate NTN cells.

In an eighth additional aspect, alone or in combination with one or more of the first through seventh aspects, the indication to perform LTM is specific to the UE.

In a ninth additional aspect, alone or in combination with one or more of the first through eighth aspects, the indication to perform LTM includes a payload that contains at least one of: one or more configuration identifiers associated with the one or more LTM candidate NTN cells, one or more timing adjustment parameters associated with the one or more LTM candidate NTN cells, or one or more beam identifiers associated with the one or more LTM candidate NTN cells.

In a tenth additional aspect, alone or in combination with one or more of the first through ninth aspects, the indication to perform LTM is associated with a plurality of UEs including the UE.

In an eleventh additional aspect, alone or in combination with one or more of the first through tenth aspects, the RRC reconfiguration message indicates a group identifier associated with the plurality of UEs.

In a twelfth additional aspect, alone or in combination with one or more of the first through eleventh aspects, the indication to perform LTM indicates a group identifier associated with the plurality of UEs.

In a thirteenth additional aspect, alone or in combination with one or more of the first through twelfth aspects, the indication to perform LTM explicitly indicates a group identifier or indicates a bitmap associated with the group identifier, and the plurality of UEs are configured to perform LTM using respective LTM configurations.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, at a network node or an apparatus of a network node that supports LTM for NTNs in accordance with the present disclosure. Example process 1100 is an example where the apparatus or the network node (for example, network node 110) performs operations associated with LTM for NTNs.

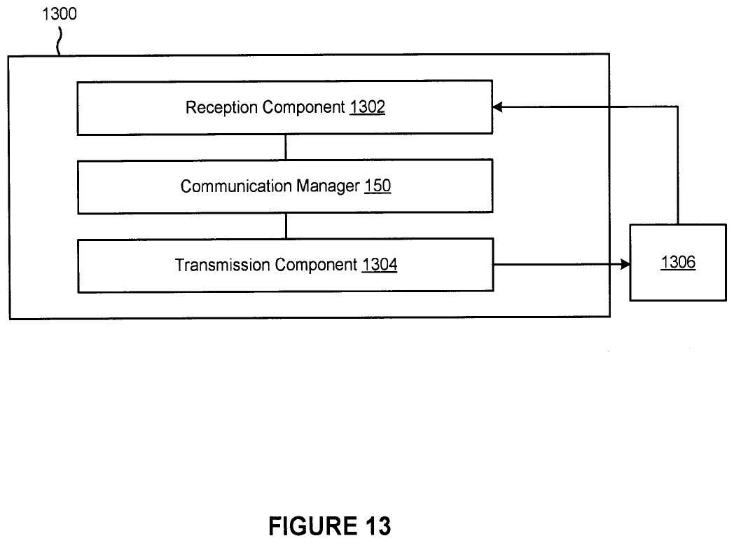

As shown in FIG. 11, in some aspects, process 1100 may include transmitting an RRC reconfiguration message associated with one or more LTM candidate NTN cells (block 1110). For example, the network node (such as by using communication manager 150 or transmission component 1304, depicted in FIG. 13) may transmit an RRC reconfiguration message associated with one or more LTM candidate NTN cells, as described above.

As further shown in FIG. 11, in some aspects, process 1100 may include initiating, after transmitting the RRC reconfiguration message, LTM using an indication to perform LTM (block 1120). For example, the network node (such as by using communication manager 150, depicted in FIG. 13) may initiate, after transmitting the RRC reconfiguration message, LTM using an indication to perform LTM, as described above.

Process 1100 may include additional aspects, such as any single aspect or any combination of aspects described below or in connection with one or more other processes described elsewhere herein.

In a first additional aspect, the RRC reconfiguration message indicates a plurality of groups associated with a plurality of LTM candidate NTN cells including the one or more LTM candidate NTN cells.

In a second additional aspect, alone or in combination with the first aspect, the indication to perform LTM is specific to a UE.

In a third additional aspect, alone or in combination with one or more of the first and second aspects, the indication to perform LTM includes a payload that contains at least one of one or more configuration identifiers associated with the one or more LTM candidate NTN cells, one or more timing adjustment parameters associated with the one or more LTM candidate NTN cells, or one or more beam identifiers associated with the one or more LTM candidate NTN cells.

In a fourth additional aspect, alone or in combination with one or more of the first through third aspects, the indication to perform LTM is associated with a plurality of UEs.

In a fifth additional aspect, alone or in combination with one or more of the first through fourth aspects, the RRC reconfiguration message indicates a group identifier associated with the plurality of UEs.

In a sixth additional aspect, alone or in combination with one or more of the first through fifth aspects, the indication to perform LTM indicates a group identifier associated with the plurality of UEs.

In a seventh additional aspect, alone or in combination with one or more of the first through sixth aspects, the RRC reconfiguration message includes one or more satellite identifiers associated with the one or more LTM candidate NTN cells.

In an eighth additional aspect, alone or in combination with one or more of the first through seventh aspects, process 1100 includes receiving one or more L1 measurement reports associated with one or more L1 measurements.

In a ninth additional aspect, alone or in combination with one or more of the first through eighth aspects, the one or more LTM candidate NTN cells are a single LTM candidate NTN cell, the one or more L1 measurement reports are a single L1 measurement report, and the single L1 measurement report does not contain a cell identifier associated with the single LTM candidate NTN cell.

In a tenth additional aspect, alone or in combination with one or more of the first through ninth aspects, the RRC reconfiguration message includes a plurality of configuration identifiers associated with a plurality of LTM candidate NTN cells including the one or more LTM candidate NTN cells.

In an eleventh additional aspect, alone or in combination with one or more of the first through tenth aspects, the indication to perform LTM explicitly indicates a group identifier or indicates a bitmap associated with the group identifier, and the plurality of UEs are configured to perform LTM using respective LTM configurations.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports LTM for NTNs in accordance with the present disclosure. The apparatus 1200 may be a UE, or a UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIG. 9. Additionally or alternatively, the apparatus 1200 may be configured to and/or operable to perform one or more processes described herein, such as process 1000 of FIG. 10. In some aspects, the apparatus 1200 may include one or more components of the UE described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, one or more modems, one or more demodulators, one or more MIMO detectors, one or more receive processors, one or more controllers/processors, and/or one or more memories of the UE described above in connection with FIG. 2.

The transmission component 1204 may transmit communications, such as reference signals, control information, and/or data communications, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 1204 may be co-located with the reception component 1202 in one or more transceivers.

The communication manager 140 may receive or may cause the reception component 1202 to receive an RRC reconfiguration message associated with one or more LTM candidate NTN cells. The communication manager 140 may perform, after receiving the RRC reconfiguration message, LTM responsive to an indication to perform LTM. In some aspects, the communication manager 140 may perform one or more operations described elsewhere herein as being performed by one or more components of the communication manager 140.

The communication manager 140 may include one or more controllers/processors and/or one or more memories of the UE described above in connection with FIG. 2. In some aspects, the communication manager 140 includes a set of components, such as a measurement component 1208, and/or a performing component 1210. Alternatively, the set of components may be separate and distinct from the communication manager 140. In some aspects, one or more components of the set of components may include or may be implemented within one or more controllers/processors and/or one or more memories of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive an RRC reconfiguration message associated with one or more LTM candidate NTN cells. The performing component 1210 may perform, after receiving the RRC reconfiguration message, LTM responsive to an indication to perform LTM.

The measurement component 1208 may perform, responsive to the one or more LTM candidate NTN cells being within a range of the UE, one or more L1 measurements associated with the one or more LTM candidate NTN cells.

The transmission component 1204 may transmit one or more L1 measurement reports associated with the one or more L1 measurements.

The performing component 1210 may perform LTM responsive to a location of the UE or a current time.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports LTM for NTNs in accordance with the present disclosure. The apparatus 1300 may be a network node, or a network node may include the apparatus 1300. In some aspects, the apparatus 1300 includes a reception component 1302, a transmission component 1304, and a communication manager 150, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to and/or operable to perform one or more operations described herein in connection with FIG. 9. Additionally or alternatively, the apparatus 1300 may be configured to and/or operable to perform one or more processes described herein, such as process 1100 of FIG. 11. In some aspects, the apparatus 1300 may include one or more components of the network node described above in connection with FIG. 2.

The reception component 1302 may receive communications, such as reference signals, control information, and/or data communications, from the apparatus 1306. The reception component 1302 may provide received communications to one or more other components of the apparatus 1300, such as the communication manager 150. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, one or more modems, one or more demodulators, one or more MIMO detectors, one or more receive processors, one or more controllers/processors, and/or one or more memories of the network node described above in connection with FIG. 2.

The transmission component 1304 may transmit communications, such as reference signals, control information, and/or data communications, to the apparatus 1306. In some aspects, the communication manager 150 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1304 may be co-located with the reception component 1302 in one or more transceivers.

The communication manager 150 may transmit or may cause the transmission component 1304 to transmit an RRC reconfiguration message associated with one or more LTM candidate NTN cells. The communication manager 150 may initiate, after transmitting the RRC reconfiguration message, LTM using an indication to perform LTM. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1304 may transmit an RRC reconfiguration message associated with one or more LTM candidate NTN cells. The communication manager 150 may initiate, after transmitting the RRC reconfiguration message, LTM using an indication to perform LTM.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: receiving an RRC reconfiguration message associated with one or more LTM candidate NTN cells; and performing, after receiving the RRC reconfiguration message, LTM responsive to an indication to perform LTM.

Aspect 2: The method of Aspect 1, wherein the RRC reconfiguration message includes one or more satellite identifiers associated with the one or more LTM candidate NTN cells.

Aspect 3: The method of any of Aspects 1-2, further comprising: performing, responsive to the one or more LTM candidate NTN cells being within a range of the UE, one or more L1 measurements associated with the one or more LTM candidate NTN cells; and transmitting one or more L1 measurement reports associated with the one or more L1 measurements.

Aspect 4: The method of Aspect 3, wherein performing the one or more L1 measurements includes performing the one or more L1 measurements responsive to a current time or UE location; and wherein transmitting the one or more L1 measurement reports includes transmitting the one or more L1 measurement reports responsive to the one or more L1 measurements satisfying a measurement threshold.

Aspect 5: The method of Aspect 3, wherein the one or more LTM candidate NTN cells are a single LTM candidate NTN cell, wherein the one or more L1 measurement reports are a single L1 measurement report, and wherein the single L1 measurement report does not contain a cell identifier associated with the single LTM candidate NTN cell.

Aspect 6: The method of any of Aspects 1-5, wherein the RRC reconfiguration message includes a plurality of configuration identifiers associated with a plurality of LTM candidate NTN cells including the one or more LTM candidate NTN cells, and wherein performing LTM includes performing LTM responsive to an order associated with the plurality of configuration identifiers.

Aspect 7: The method of any of Aspects 1-6, wherein performing LTM includes performing LTM responsive to a location of the UE or a current time.

Aspect 8: The method of any of Aspects 1-7, wherein the RRC reconfiguration message indicates a plurality of groups associated with a plurality of LTM candidate NTN cells including the one or more LTM candidate NTN cells.

Aspect 9: The method of any of Aspects 1-8, wherein the indication to perform LTM is specific to the UE.

Aspect 10: The method of Aspect 9, wherein the indication to perform LTM includes a payload that contains at least one of: one or more configuration identifiers associated with the one or more LTM candidate NTN cells, one or more timing adjustment parameters associated with the one or more LTM candidate NTN cells, or one or more beam identifiers associated with the one or more LTM candidate NTN cells.

Aspect 11: The method of any of Aspects 1-10, wherein the indication to perform LTM is associated with a plurality of UEs including the UE.

Aspect 12: The method of Aspect 11, wherein the RRC reconfiguration message indicates a group identifier associated with the plurality of UEs.

Aspect 13: The method of Aspect 11, wherein the indication to perform LTM indicates a group identifier associated with the plurality of UEs.

Aspect 14: A method of wireless communication performed by a network node, comprising: transmitting an RRC reconfiguration message associated with one or more LTM candidate NTN cells; and initiating, after transmitting the RRC reconfiguration message, LTM using an indication to perform LTM.

Aspect 15: The method of Aspect 14, wherein the RRC reconfiguration message includes one or more satellite identifiers associated with the one or more LTM candidate NTN cells.

Aspect 16: The method of any of Aspects 14-15, further comprising: receiving one or more L1 measurement reports associated with one or more L1 measurements.

Aspect 17: The method of Aspect 16, wherein the one or more LTM candidate NTN cells are a single LTM candidate NTN cell, wherein the one or more L1 measurement reports are a single L1 measurement report, and wherein the single L1 measurement report does not contain a cell identifier associated with the single LTM candidate NTN cell.

Aspect 18: The method of any of Aspects 14-17, wherein the RRC reconfiguration message includes a plurality of configuration identifiers associated with a plurality of LTM candidate NTN cells including the one or more LTM candidate NTN cells.

Aspect 19: The method of Aspect 18, wherein the RRC reconfiguration message indicates a plurality of groups associated with a plurality of LTM candidate NTN cells including the one or more LTM candidate NTN cells.

Aspect 20: The method of any of Aspects 14-19, wherein the indication to perform LTM is specific to a UE.

Aspect 21: The method of Aspect 20, wherein the indication to perform LTM includes a payload that contains at least one of: one or more configuration identifiers associated with the one or more LTM candidate NTN cells, one or more timing adjustment parameters associated with the one or more LTM candidate NTN cells, or one or more beam identifiers associated with the one or more LTM candidate NTN cells.

Aspect 22: The method of any of Aspects 14-21, wherein the indication to perform LTM is associated with a plurality of UEs.

Aspect 23: The method of Aspect 22, wherein the RRC reconfiguration message indicates a group identifier associated with the plurality of UEs.

Aspect 24: The method of Aspect 22, wherein the indication to perform LTM indicates a group identifier associated with the plurality of UEs.

Aspect 25: The method of Aspect 24, wherein the indication to perform LTM explicitly indicates a group identifier or indicates a bitmap associated with the group identifier, and wherein the plurality of UEs are configured to perform LTM using respective LTM configurations.

Aspect 26: The method of Aspect 13, wherein the indication to perform LTM explicitly indicates a group identifier or indicates a bitmap associated with the group identifier, and wherein the plurality of UEs are configured to perform LTM using respective LTM configurations.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive a radio resource control (RRC) reconfiguration message associated with one or more layer 1 (L1) or layer 2 (L2) triggered mobility (LTM) candidate non-terrestrial network (NTN) cells; and
perform, after receiving the RRC reconfiguration message, LTM responsive to an indication to perform LTM.

2. The apparatus of claim 1, wherein the RRC reconfiguration message includes one or more satellite identifiers associated with the one or more LTM candidate NTN cells.

3. The apparatus of claim 1, wherein at least one processor of the one or more processors is further configured to cause the UE to:
perform, responsive to the one or more LTM candidate NTN cells being within a range of the UE, one or more L1 measurements associated with the one or more LTM candidate NTN cells; and
transmit one or more L1 measurement reports associated with the one or more L1 measurements.

4. The apparatus of claim 3, wherein the at least one processor configured to cause the UE to perform the one or more L1 measurements is further configured to cause the UE to perform the one or more L1 measurements responsive to a current time or UE location, and
wherein the at least one processor configured to cause the UE to transmit the one or more L1 measurement reports is further configured to cause the UE to transmit the one or more L1 measurement reports responsive to the one or more L1 measurements satisfying a measurement threshold.

5. The apparatus of claim 3, wherein the one or more LTM candidate NTN cells are a single LTM candidate NTN cell, wherein the one or more L1 measurement reports are a single L1 measurement report, and wherein the single L1 measurement report does not contain a cell identifier associated with the single LTM candidate NTN cell.

6. The apparatus of claim 1, wherein the RRC reconfiguration message includes a plurality of configuration identifiers associated with a plurality of LTM candidate NTN cells including the one or more LTM candidate NTN cells, and wherein the at least one processor configured to cause the UE to perform LTM is further configured to cause the UE to:
perform LTM responsive to an order associated with the plurality of configuration identifiers.

7. The apparatus of claim 1, wherein the at least one processor configured to cause the UE to perform LTM is further configured to cause the UE to:
perform LTM responsive to a location of the UE or a current time.

8. An apparatus for wireless communication at a network node, comprising:
one or more memories storing processor-executable code; and
one or more processors coupled with the one or more memories, at least one processor of the one or more processors configured to cause the network node to:
transmit a radio resource control (RRC) reconfiguration message associated with one or more layer 1 (L1) or layer 2 (L2) triggered mobility (LTM) candidate non-terrestrial network (NTN) cells; and
initiate, after transmitting the RRC reconfiguration message, LTM using an indication to perform LTM.

9. The apparatus of claim 8, wherein the RRC reconfiguration message indicates a plurality of groups associated with a plurality of LTM candidate NTN cells including the one or more LTM candidate NTN cells.

10. The apparatus of claim 8, wherein the indication to perform LTM is specific to a user equipment (UE).

11. The apparatus of claim 10, wherein the indication to perform LTM includes a payload that contains at least one of: one or more configuration identifiers associated with the one or more LTM candidate NTN cells, one or more timing adjustment parameters associated with the one or more LTM candidate NTN cells, or one or more beam identifiers associated with the one or more LTM candidate NTN cells.

12. The apparatus of claim 8, wherein the indication to perform LTM is associated with a plurality of user equipments (UEs).

13. The apparatus of claim 12, wherein the RRC reconfiguration message indicates a group identifier associated with the plurality of UEs.

14. The apparatus of claim 12, wherein the indication to perform LTM indicates a group identifier associated with the plurality of UEs.

15. The apparatus of claim 14, wherein the indication to perform LTM explicitly indicates a group identifier or indicates a bitmap associated with the group identifier, and wherein the plurality of UEs are configured to perform LTM using respective LTM configurations.

16. A method of wireless communication performed by a user equipment (UE), comprising:
receiving a radio resource control (RRC) reconfiguration message associated with one or more layer 1 (L1) or layer 2 (L2) triggered mobility (LTM) candidate non-terrestrial network (NTN) cells; and
performing, after receiving the RRC reconfiguration message, LTM responsive to an indication to perform LTM.

17. The method of claim 16, wherein the RRC reconfiguration message indicates a plurality of groups associated with a plurality of LTM candidate NTN cells including the one or more LTM candidate NTN cells.

18. The method of claim 16, wherein the indication to perform LTM is specific to the UE, or the indication to perform LTM is associated with a plurality of UEs including the UE.

19. The method of claim 18, wherein the RRC reconfiguration message indicates a group identifier associated with the plurality of UEs.

20. The method of claim 18, wherein the indication to perform LTM indicates a group identifier associated with the plurality of UEs.
